(19) United States
(12) Patent Application Publication
(10) Pub. No.: US 2016/0346952 A1
(43) Pub. Date: Dec. 1, 2016

(54) COMBINATION THREE-HOLE PUNCH AND TWO-HOLE PUNCH

(71) Applicant: Janyce Rossall, Reno, NV (US)

(72) Inventor: Janyce Rossall, Reno, NV (US)

(21) Appl. No.: 15/167,183

(22) Filed: May 27, 2016

Related U.S. Application Data
(60) Provisional application No. 62/168,637, filed on May 29, 2015.

(51) Int. Cl. B26F 1/36; B26D 5/10

(52) U.S. Cl. CPC B26F 1/36; B26D 5/10; B26D 2007/0087

(57) ABSTRACT

Described herein is a device that combines a three-hole punch and a two-hole punch. The device includes four punches in alignment that in combination form a distinct three-hole punch and distinct two-hole punch.

### CROSS REFERENCE TO RELATED APPLICATIONS

This application claims priority to U.S. Provisional Patent Application No. 62/168,637 filed 29 May 2015 to the above named inventor, and is herein incorporated by reference in its entirety.

### FIELD OF THE INVENTION

The invention relates generally to a device that combines a three-hole punch and a two-hole punch into one unit.

### BACKGROUND

Within North America, and the United States in particular, the preferred paper size is US Letter having a size of 8.5 inches by 11 inches (220 mm by 360 mm). To organize this paper size individuals often utilize two main hole-punch conventions; a three-hole system and a two-hole system. A three-hole punch system typically involves the punching of the edge of the paper along its length and placing the punched paper into a three-ring binder or similar device. These three holes are positioned symmetrically with the centers 4.25 inches (108 mm) apart. A two-hole punch system typically involves punching the top edge of the paper along its width and securing the punched paper within a clip that is sometimes affixed to a folder. The two holes are positioned symmetrically along the top edge with the centers spaced 2.75 inches (70 mm) apart. The typical diameter of the holes punched within the two-hole and the three-hole system is between ¼ to 5/16 of an inch.

Currently there are a number of solutions for punching these holes in documents. Some of these solutions attempt to have a hole punch with movable punch guides, but these solutions fail to meet the needs of the market because the guides are notorious for becoming dislodged and punching misaligned holes. Other solutions attempt to have a stationary hole punch, but these solutions are similarly unable to meet the needs of the market because a two-hole and a three-hole punch must be purchased separately. Still other solutions seek to purchase two-hole and three-hole punches separately, but these solutions also fail to meet market needs because of cost and the space it takes up on a person's desk. Therefore, there is a need for an improved hole-punch device that allows for use for both the two-hole and the three-hole punching conventions.

### SUMMARY OF THE INVENTION

It would be advantageous to have an apparatus that is a combination of a three-hole punch and a two-hole punch. Furthermore, it would also be advantageous to have an apparatus that has stationary paper guides to avoid misalignment during the hole punching process. It would also be advantageous to have an apparatus that would be a staple device in law offices, doctors' offices, schools, and libraries. Therefore, there currently exists a need in the market for an apparatus that combines a three-hole and a two-hole paper punch into one convenient and robust design that saves room on a work surface. Preferably, the apparatus has permanent paper guides and an open design to eliminate misaligned holes.

The invention advantageously fills the aforementioned deficiencies by providing a device that combines a three-hole punch and a two-hole punch that provides a properly aligned punch each and every time.

The invention is a combination three-hole and two-hole punch utilizing four individually placed and strategically spaced hole punches and permanent paper guides.

The apparatus has permanent paper guides that eliminate misaligned holes.

The apparatus has a rubberized tray to prevent slipping and act as a receptacle to collect the punched out paper holes and a rubberized lever for comfort during use.

The apparatus fulfills the need in law offices, doctors' offices, copy stores, schools, libraries, and work rooms; wherever two-hole punches and three-hole punches are needed.

Among other things, it is an advantage of the invention to provide a device that combines a three-hole punch and a two-hole punch that does not suffer from any of the problems or deficiencies associated with prior solutions.

It is still further an advantage of the invention to have space saving properties due to combining two functions into one device; punching three holes simultaneously and two holes simultaneously into paper.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete, and will fully convey the entire scope of the invention to those skilled in the art.

### BRIEF DESCRIPTION OF THE DRAWINGS

FIG. 1 shows the front view of the combination three-hole and two-hole punch device, according to the present invention;

FIG. 2 shows an isometric rear side view of the device, according to the present invention; and

FIG. 3 shows an isometric front side view of the device, according to the present invention.

### DETAILED DESCRIPTION OF THE INVENTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the figures, with “front,” “back,” and “rear” being relative to the apparatus.

These terms are not meant to limit the elements that they describe, as the various elements may be oriented differently in various applications.

As used herein, the term “coupled” means the joining of two members directly or indirectly to one another. Such joining may be stationary in nature or movable in nature and/or such joining may allow for the flow of electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The invention is directed to be a device that combines a three-hole punch and a two-hole punch into a single device.

The invention is a device that combines a three-hole and a two-hole paper punch into one convenient design that saves room on a work surface. The device includes permanent paper guides and an open design to eliminate misaligned holes.

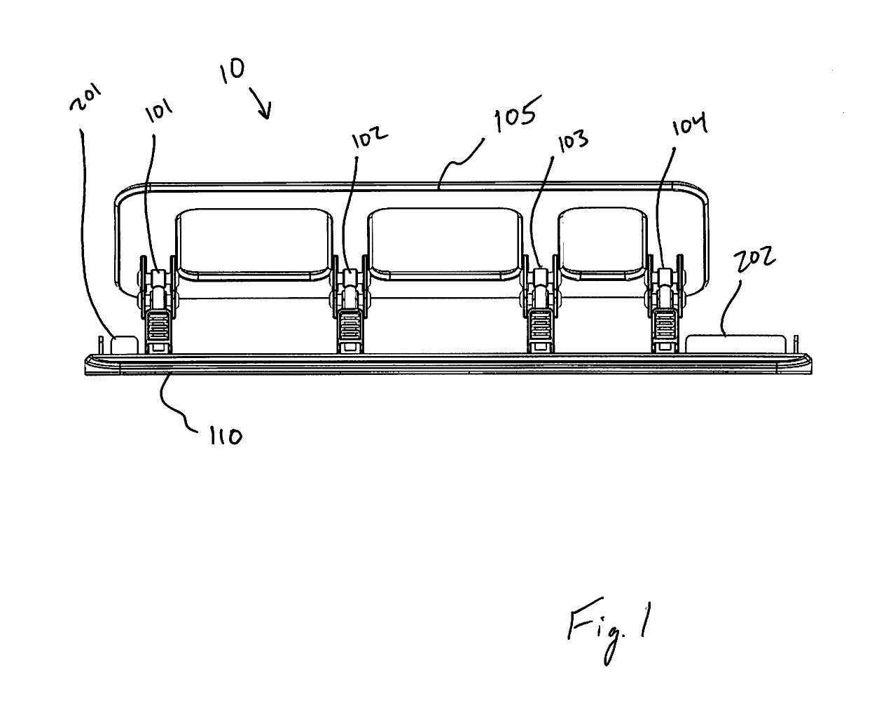

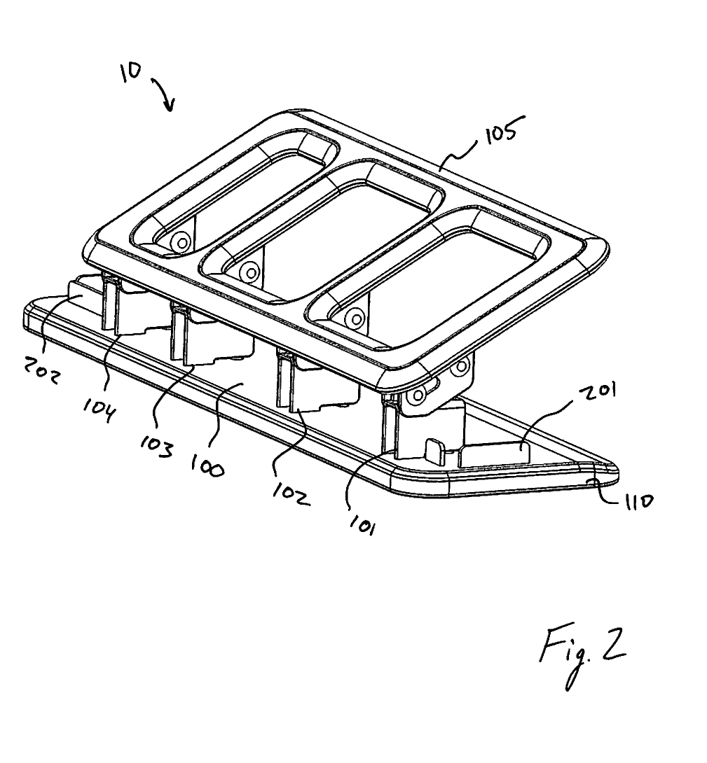

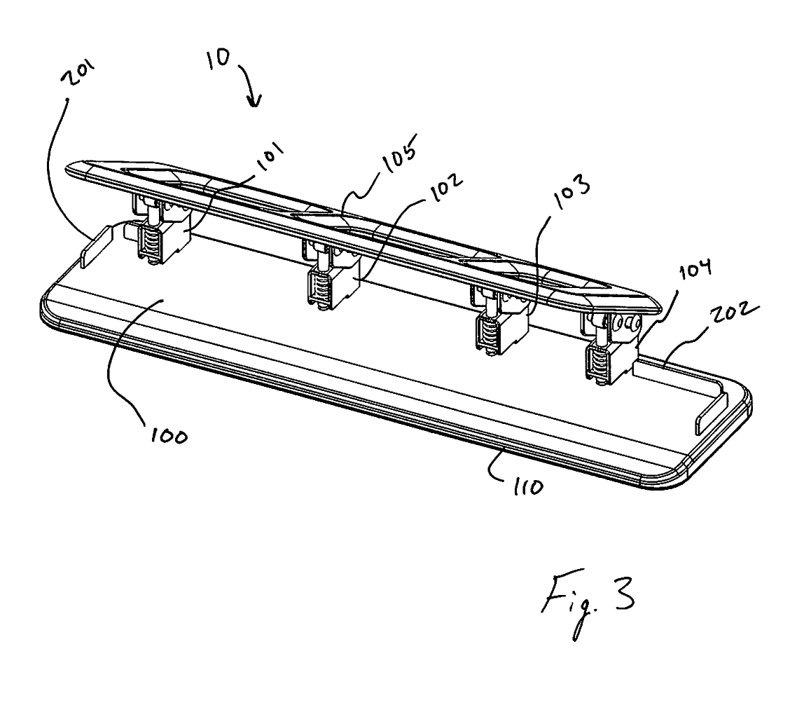

Referring to the figures, FIGS. 1-3 show the combination three-hole punch and two-hole punch according to the present invention and generally referred to as device 10. The combination three-hole punch and two-hole punch device 10 includes a base portion 100, a first punch 101, a second punch 102, a third punch 103, a fourth punch 104, and a handle 105. Each of the punches 101-104 is cylindrical in shape, in coupled communication with the handle 105, and includes a compliant member, such as a compressed spring, wherein a downward force of the handle engages the punches 101-104 of the device 10 cutting a defined hole into the paper. The first punch 101, the second punch 102, and the third punch 103 are symmetrically spaced and aligned to form a standard three-hole punch as is common with the art. Preferably, this spacing is 4.25 inches (108 mm) apart as measured from the center of each of the punches 101-103. A first guide 201 is located adjacent to the first punch 101 and allows for proper alignment of inserted paper for a three-hole style punch. The first guide 201 having both a horizontal and a vertical alignment feature, wherein a corner of the paper to be punched is placed adjacent to the guide with the length of the paper to be punched extending from the first punch 101 to the third punch 103.

The third punch 103 and the fourth punch 104 are spaced and aligned to form a standard two-hole punch as is common within the art. Accordingly and preferably, the fourth punch 104 and the third punch 103 are 2.75 inches (75 mm) apart as measured from the center of the punches 103-104. A second guide 202 is located adjacent to the fourth punch 104 and allows for proper alignment of inserted paper for a two-hole style punch. The second guide 202 having both a horizontal and a vertical alignment feature, wherein a corner of the paper to be punched is placed adjacent to the guide with a width of the paper to be punched extending from the fourth punch 104 to the third punch 103.

The base portion 100 is substantially hollow and includes rubberized tray 110 to capture the punched paper and provide anti-skid resistance during use.

The term punch is used throughout this specification to refer to a mechanism that places an aperture into paper. Accordingly punches are well known within the art and are typically comprised of a cylindrical shaped rod sized to the hole to be cut and including a beveled bottom cutting surface designed for the cutting and removal of paper. This rod is typically surrounded by a compressed spring and biased through movement of the handle, wherein a downward force of the handle contacts the rod, biases the spring, and cuts a cylindrical aperture into paper placed below the punch.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A hole punch, the hole punch capable of punching an aperture into a paper sheet, the hole punch comprising:
a first punch;
a second punch;
a third punch, the first punch, the second punch, and the third punch spaced equidistant and symmetrically apart to form a standard three-hole punch; and
a fourth punch, the fourth punch spaced symmetrically apart from the third punch a distance corresponding to a standard two-hole punch.

2. A device as in claim 1, wherein the first punch, the second punch, and the third punch are spaced symmetrically apart a distance of four and one-quarter (4.25) inches.

3. A device as in claim 1, wherein the fourth punch is placed symmetrically apart from the third punch a distance of two and three-quarters (2.75) inches.

4. A device as in claim 1, wherein a first alignment guide is positioned adjacent to the first hole punch and a second alignment guide is placed adjacent to the fourth hole punch, the first alignment guide used to aid in punching a length of the paper and the second alignment guide used to in aid punching a width of the paper.

5. A hole punching device for punching holes in paper sheet material, the device comprising:
a first hole punch, the first hole punch cylindrical in shape and capable of cutting a hole into paper;
a second hole punch, the second hole punch cylindrical in shape and capable of cutting a hole into paper;
a third hole punch, the third hole punch cylindrical in shape and capable of cutting a hole into paper, the first hole punch, the second hole punch, and the third hole punch aligned and spaced equidistant apart a distance corresponding to a standard three-hole punch;
a fourth hole punch, the fourth hole punch cylindrical in shape and capable of cutting a hole into paper, the fourth hole punch aligned with the third hole punch and spaced a distance corresponding to the distance of a standard two-hole punch; and
a handle, the handle in hinged communication with the first hole punch, the second hole punch, the third hole punch, and the fourth hole punch, wherein downward pressure on the handle allows a user to utilize the hole punching device to punch either a three-hole punch or a two-hole punch.

6. A device as in claim 5, wherein the first hole punch, the second hole punch, and the third hole punch are spaced symmetrically apart a distance of four and one-quarter (4.25) inches.

7. A device as in claim 5, wherein the fourth hole punch is placed symmetrically apart from the third hole punch a distance of two and three-quarters (2.75) inches.

8. A device as in claim 5, wherein a first alignment guide is positioned adjacent to the first hole punch and a second alignment guide is placed adjacent to the fourth hole punch, the first alignment guide used to aid in punching a length of the paper and the second alignment guide used to aid in punching a width of the paper.

9. A hole punch for paper sheet material, the punch adapted for use as both as three-hole punch and a two-hole punch, the punch comprising:
a first hole punch;
a second hole punch, the second hole punch aligned with the first hole punch, the second hole punch located a distance away from the first hole punch as measured from the center of the first hole punch a distance of four and one-quarter (4.25) inches;
a third hole punch, the third hole punch aligned with the first hole punch and the second hole punch, the third hole punch located a distance away from the second hole punch as measured from the center of the second hole punch a distance of four and one-quarter (4.25) inches, wherein the first hole punch, the second hole punch, and the third hole punch are spaced equidistant and symmetrically apart to form a standard three-hole punch; and
a fourth hole punch, the fourth hole punch spaced symmetrically apart from the third hole punch a distance of two and three-quarters (2.75) inches, wherein the distance between the third hole punch and the fourth hole punch corresponds to the distance of a standard two-hole punch.

10. A device as in claim 9, wherein a first alignment guide is positioned adjacent to the first hole punch and a second alignment guide is placed adjacent to the fourth hole punch, the first alignment guide used to aid in punching a length of the paper and the second alignment guide used to aid in punching a width of the paper.
